(19) United States
(12) Patent Application Publication
(10) Pub. No.: US 2017/0148363 A1
(43) Pub. Date: May 25, 2017

(54) Illuminated Sign Device

(71) Applicant: Darrell Frycz, Northfield, OH (US)

(72) Inventor: Darrell Frycz, Northfield, OH (US)

(21) Appl. No.: 15/157,975

(22) Filed: May 18, 2016

Related U.S. Application Data
(60) Provisional application No. 62/259,986, filed on Nov. 25, 2015.

(51) Int. Cl. G09F 13/18; G09F 7/18; G09F 13/22; G09F 13/00

(52) U.S. Cl. CPC G09F 13/18; G09F 13/005; G09F 7/18; G09F 13/22; G09F 2013/1877; G09F 2007/1847; G09F 2013/222

(57) ABSTRACT

An illuminated sign device for use in illuminating any of various signs. The illuminated sign device includes a support having a channel thereon, wherein the channel removably receives a sign having indicia thereon. Signs having different indicia thereon can be removably positioned within the channel to allow the user to easily and quickly replace the sign. The channel includes one or more light sources therein adapted to illuminate the sign and the indicia thereon when the sign is secured within the channel via one or more fasteners. The support can be arranged in a standing position or can be hung on a wall, depending upon the embodiment.

### CROSS REFERENCE TO RELATED APPLICATION

This application claims the benefit of U.S. Provisional Application No. 62/259,986 filed on Nov. 25, 2015. The above identified patent application is herein incorporated by reference in its entirety to provide continuity of disclosure.

### BACKGROUND OF THE INVENTION

### Field of the Invention

The present invention relates to signs. More specifically, the present invention provides an illuminated sign device comprising a support having a channel in which an edge of a sign can be removably secured via one or more fasteners, wherein a light source positioned within the channel is adapted to illuminate the sign and the indicia thereon.

Illuminated signs are commonly used in order to advertise a product or business. Such signs have improved visibility and can be easily read in low light conditions or at night. Further, the illumination helps to draw additional attention to the sign and provides visual interest. This helps the owner of the sign to draw customers into their business or to spread awareness of a brand or product.

However, signs can be expensive to produce and often have to be specially designed and constructed. For example, neon signs include a custom made curved tube or tubes filled with a neon gas that glows brightly when the gas is excited. Such signs can be very costly due to the cost of specially designing and preparing the tubes.

Other types of signs comprise a base panel and a plurality of point light sources thereon, such as LEDs. Such signs require a specific arrangement of LEDs thereon and may require numerous LEDs. Again, such signs can be very costly to prepare. Further, such signs are not adjustable and once the sign is produced it cannot be altered in anyway. Thus, if a user wishes to display a new image, name, or logo, the user will have to order or prepare a new sign and dispose of the previous sign, which can be expensive and inconvenient.

Devices have been disclosed in the prior art that relate to illuminated signs. These include devices that have been patented and published in patent application publications. These devices generally relate to edge-lit signs, such as U.S. Published Patent Application Number 2011/0072696, U.S. Published Patent Application Number 2014/0196328, U.S. Published Patent Application Number 2011/0051395, U.S. Published Patent Application Number 2011/0219648, and U.S. Pat. No. 6,732,478.

These prior art devices have several known drawbacks. The devices in the prior art provide illuminated signs, but do not allow the user to easily remove or replace a sign held within a channel. Further, such devices do not allow the user to either stand the sign in an upright orientation or hang the sign from a support surface. Thus, the present invention provides improved usability and versatility so as to suit various applications.

In light of the devices disclosed in the prior art, it is submitted that the present invention substantially diverges in design elements from the prior art and consequently it is clear that there is a need in the art for an improvement to existing illuminated sign devices. In this regard the instant invention substantially fulfills these needs.

### SUMMARY OF THE INVENTION

In view of the foregoing disadvantages inherent in the known types of illuminated signs now present in the prior art, the present invention provides a new illuminated sign device wherein the same can be utilized for providing convenience for the user when displaying a sign.

The present invention provides an illuminated sign comprising a support that removably receives a sign therein. The support includes a channel having one or more light sources therein adapted to illuminate the edge of the sign that is secured within the channel. The channel includes any of various indicia thereon, wherein the light source is adapted to illuminate the indicia so as to allow the indicia to be more visible and more easily read. The sign is secured within the channel via any of various fasteners, such as screws. Further, the support may include one or more feet for standing the sign in an upright orientation or may include a hanger for suspending the sign from a support structure, such as a hook.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the illuminated sign device.

FIG. 2A shows a front plan view of the illuminated sign as positioned for insertion.

FIG. 2B shows a front plan view of the illuminated sign as inserted.

FIG. 3A shows a perspective view of a first embodiment of the illuminated sign device.

FIG. 3B shows a perspective view of an alternate embodiment of the illuminated sign device.

FIG. 4 shows a perspective view of multiple illuminated signs connected to one another.

### DETAILED DESCRIPTION OF THE INVENTION

Reference is made herein to the attached drawings. Like reference numerals are used throughout the drawings to depict like or similar elements of the illuminated sign device. For the purposes of presenting a brief and clear description of the present invention, the preferred embodiment will be discussed as used for providing an illuminated sign that is easily installed. The figures are intended for representative purposes only and should not be considered to be limiting in any respect.

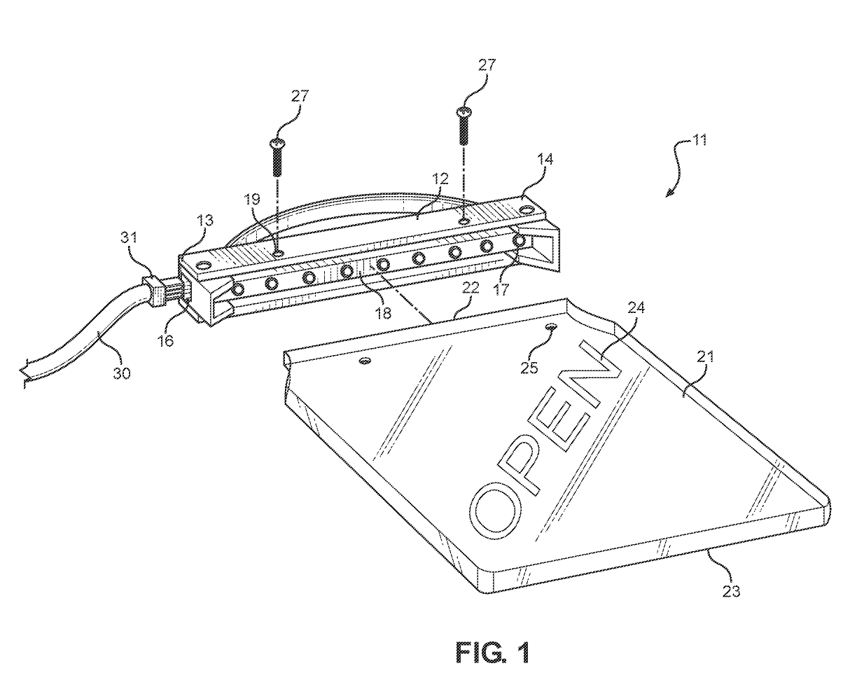

Referring now to FIG. 1, there is shown a perspective view of the illuminated sign device. The illuminated sign device 11 comprises a support 12 adapted to removably receive a sign 21 therein. The support 12 includes a light source 18 therein adapted to illuminate the sign 21 when the sign 21 is secured therein. The light source 18 is preferably one or more LED lights arranged in one or more rows. The light source is directed outward from the support 12. The support 12 includes a port 16 adapted to removably receive an adapter 31 disposed on an elongated cable 30 for providing electricity to the light source 18 for powering the same. It is not desired to limit the invention to any specific port and adapter, so long as the adapter 31 removably engages the port 16 so as to provide electricity to the light source 18 therein.

The support 12 has a substantially rectangular shape and comprises a first end 13 opposite a second end 14. An interior surface of the support 12 comprises a channel 17 thereon adapted to receive a leading edge 22 of the sign 21. The channel 17 extends along the length of the support 12. The light source 18 is positioned within the channel 17 so as to be positioned along the leading edge 22 of the sign 21 when the sign 21 is inserted within the channel 17.

The sign 21 comprises a planar panel having a leading edge 22 and a trailing edge 23. The sign 21 is shown as having a substantially rectangular shape, however, in alternate embodiments, the sign 21 can have any of various shapes or configurations. The sign 21 includes indicia 24 thereon such as one or more characters, symbols, images, and the like. Preferably, the sign 21 is composed of an acrylic material and includes indicia 24 etched thereon. The indicia 24 are etched into the surface of the sign 21 so as to extend towards the interior thereof.

When the sign 21 is inserted into the support 12, the light source 18 transmits light into the sign 21 through the leading edge 22 thereof. The light scatters within the sign 21 and illuminates the indicia 24 thereon, while the remainder of the sign 21 is not illuminated. In this way, the indicia 24 on the sign 21 are illuminated and can be easily viewed by a bystander. Thus, the sign 21 can include any of various indicia 24 thereon in any of various patterns, and the light source 18 serves to fully illuminate the indicia 24.

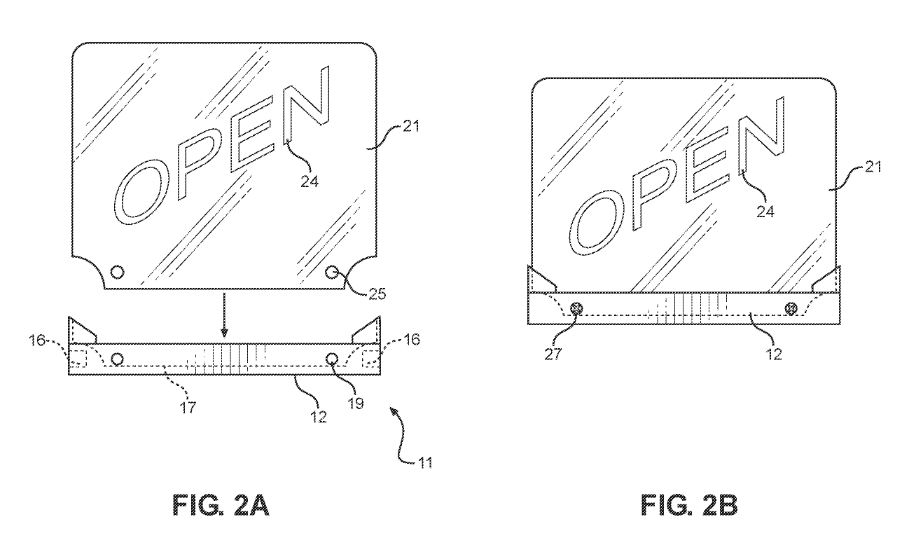

Referring now to FIGS. 2A and 2B, there is shown a front plan view of the sign as positioned for insertion and as inserted into the support of the illuminated sign device, respectively. The sides of the support 12 comprise one or more apertures 19 thereon adapted to align with apertures 25 disposed on the leading edge of the sign 21 when the sign is inserted into the channel of the support 12. When the apertures 19, 25 are aligned, a fastener 27 can be inserted into the aligned apertures in order to secure the sign to the support. The fastener is preferably a screw, or other similar threaded fastener. This allows the user to easily attach and detach the sign from the support 12 as desired.

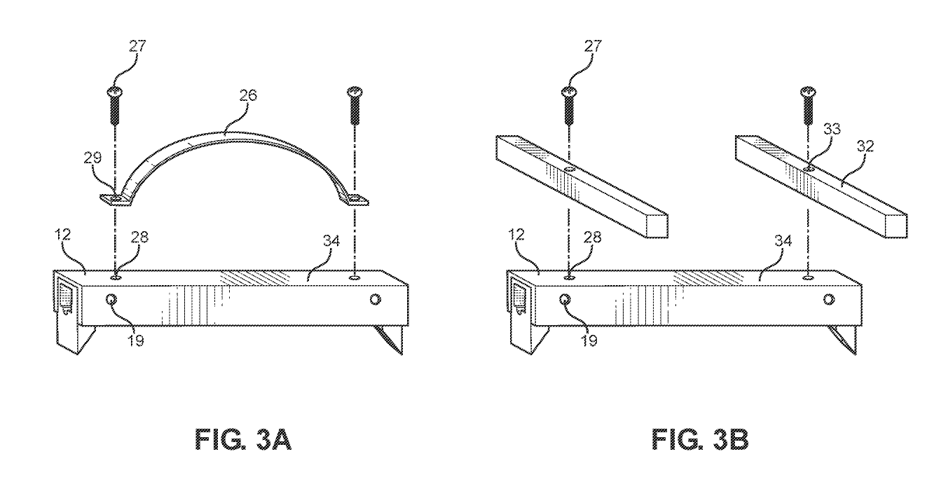

Referring now to FIGS. 3A and 3B, there is shown different embodiments of the illuminated sign device. In a first embodiment, shown in FIG. 3A, the exterior surface 34 of the support 12 comprises a pair of apertures 28 thereon. A hanger 26 includes a first end and a second end, wherein the first end and second end each include an aperture 29 thereon. The apertures 29 on the hanger 26 are adapted to be aligned with the apertures 28 on the exterior surface 34 of the support 12 and a fastener 27 is inserted through the aligned apertures 28, 29 so as to secure the hanger 26 on the support 12. Preferably, the fastener 27 is a screw, however any suitable fastener may be used.

In an alternate embodiment, as shown in FIG. 3B, the illuminated sign device 11 comprises a pair of feet 32. The feet 32 are shown as a pair of elongated rods having a central aperture 33. However, in alternate embodiments, the feet 32 may have alternate configurations. The apertures 33 on the feet 32 are adapted to be aligned with apertures 28 on the exterior surface 34 of the support 12, wherein the feet 32 are secured to the support 12 via a fastener 27, such as a screw. When secured, the feet 32 are preferably substantially perpendicular to the support 12. In this way, the feet 32 can rest on a horizontal surface, such as a table, and the sign 21 extends vertically from the support 12 for viewing. Thus, the illuminated sign device 11 is configurable for use as a standing sign or as a hanging sign depending upon whether the hanger 26 or feet 32 are secured to the support 12. This provides versatility and allows the user to display the sign in different manners.

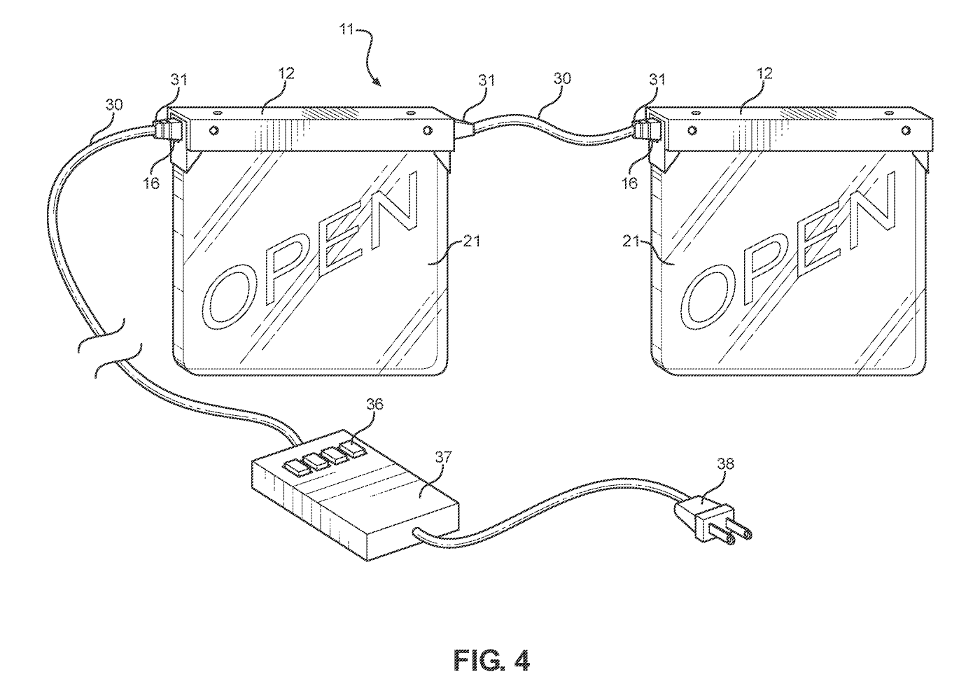

Referring now to FIG. 4, there is shown a perspective view of multiple illuminated signs connected to one another. The illuminated sign 11 comprises a port 16 on a first side thereof and a port on a second side thereof. An elongated cable 30 having an adapter 31 on each end thereof can be used to connect a first illuminated sign to a second illuminated sign so that both signs can be illuminated simultaneously. The user can continue to link a desired number of illuminated signs in this fashion.

A controller 37 allows the user to control the illumination of the light sources. The controller 37 includes one or more controls 36 thereon that allow the user to change the color of light provided by the light source and/or the intensity or brightness of the light. The controls 36 may include depressible buttons, toggle switches, dials, or the like. This allows the user to alter the appearance of the sign without physically changing the sign and its construction. The controller 37 is disposed on an electrical cable 30 comprising an electrical plug 38 that can be connected to a conventional power outlet for providing electricity to the illuminated sign or signs.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminated sign device, comprising:
a support having a first end and a second end;
a channel disposed within the support;
a light source positioned within the channel;
a sign having an indicia etched thereon, wherein a leading edge of the sign is removably positioned within the channel such that the light source illuminates the indicia on the sign.

2) The illuminated sign device of claim 1, wherein the support further comprises a first bracket positioned on a first end thereof and a second bracket disposed on a second end thereof, wherein the first bracket and the second bracket are adapted to secure the sign within the channel.

3) The illuminated sign device of claim 1, wherein the support further comprises a pair of feet removably secured thereto, wherein the pair of feet are adapted to allow the support to be positioned in an upright orientation on a horizontal support surface.

4) The illuminated sign device of claim 1, wherein the support further comprises a hanger removably secured thereto, wherein the hanger is adapted to allow the support to be secured on a vertical support surface.

5) The illuminated sign device of claim 1, wherein the sign comprises a plate having a planar configuration.

6) The illuminated sign device of claim 1, wherein the support further comprises one or more apertures thereon, and wherein the sign includes one or more apertures thereon, wherein the apertures on the support are adapted to align with the apertures on the sign such that a fastener is positionable therethrough.

7) The illuminated sign device of claim 1, wherein the support further comprises a port on a first end thereof, wherein the port is adapted to removably engage with an adapter cable that provides electricity to the light source.

8) The illuminated sign device of claim 1, wherein the support further comprises a first port and a second port, wherein one or more supports can be linked together via electrical cables extending between the ports thereon.

9) The illuminated sign device of claim 1, wherein the light source comprises a plurality of LEDs.

10) The illuminated sign device of claim 1, further comprising a controller having one or more controls thereon, wherein the controller is electrically connected to the light source so as to allow for adjustment of the color of the light source.

11) The illuminated sign device of claim 10, wherein the controller further allows for adjustment of the brightness of the light source.
